(19) United States
(12) Patent Application Publication
(10) Pub. No.: US 2020/0293309 A1
(43) Pub. Date: Sep. 17, 2020

(54) DIAGRAM MODEL FOR A PROGRAM

(71) Applicants: DEXTER RYAN SNYDER, ROY, UT (US); IA GREGORY MACISAAC, SOUTH SALT LAKE, UT (US); JESSSE J. HEIN, GRAND FORKS, ND (US); MICHAEL ANTHONY PETERSEN, WASHINGTON TERRACE, UT (US); JARED NICHOLAS SMITH, OGDEN, UT (US)

(72) Inventors: DEXTER RYAN SNYDER, ROY, UT (US); IA GREGORY MACISAAC, SOUTH SALT LAKE, UT (US); JESSSE J. HEIN, GRAND FORKS, ND (US); MICHAEL ANTHONY PETERSEN, WASHINGTON TERRACE, UT (US); JARED NICHOLAS SMITH, OGDEN, UT (US)

(73) Assignee: NORTHROP GRUMMAN SYSTEMS CORPORATION, FALLS CHURCH, VA (US)

(21) Appl. No.: 16/351,113

(22) Filed: Mar. 12, 2019

(51) Int. Cl. G06F 8/74; G06F 8/35; G06F 8/41; G06F 8/53

(52) U.S. Cl. CPC G06F 8/74; G06F 8/53; G06F 8/433; G06F 8/35

(57) ABSTRACT

In an example, a computer implemented method can include extracting a plurality of functions from assembly code representative of machine code compiled based on obfuscated source code (e.g., legacy source code), causing one or more functions of the plurality of functions to be grouped based on relationships between the plurality of functions, and defining a class for each grouping of functions. Each defined class can include a subset of functions of the plurality of functions. The method can include causing a diagram model to be generated based on the plurality of classes. The diagram model can characterize the obfuscated source code.

### TECHNICAL FIELD

The present disclosure relates to computer software. More particularly, this disclosure relates to systems and methods for generating a diagram model for a program.

### BACKGROUND

Model-driven engineering approaches are increasingly gaining acceptance in the software engineering field to tackle software complexity. These approaches promote the systematic use of modeling language, raising the level of abstraction at which software is specified and increasing the automation level of software development. Modeling language in the field of software engineering can be used to provide a standard way to visualize a design of a system. Graphical modeling language uses a diagram technique with named symbols that represent concepts and lines that connect the symbols and represent relationships and various other graphical notation to represent constrains.

Class-based programming is a programming approach based on objects and classes. The object-oriented paradigm allows software to be organized as a collection of objects that consist of both data and behavior. Objects are entities that combine stage (e.g., data), behavior (e.g., procedures or methods) and identify unique existences among all other objects. The structure and behavior of an object is defined by a class, which is a definition, or a blueprint, of all objects of a specific type.

### SUMMARY

In an example, a computer implemented method can include extracting a plurality of functions from assembly code representative of machine code compiled based on obfuscated source code of a program, causing one or more functions of the plurality of functions to be grouped based on relationships between the plurality of functions, and defining a class for each grouping of functions. Each defined class can include a subset of functions of the plurality of functions. The method can include causing a diagram model to be generated based on each of the classes. The diagram model can characterize the obfuscated source code of the program.

In another example, a system can include memory to store machine readable instructions, and one or more processors to access the memory and execute the instructions. The instructions can include an interface that can be programmed to receive assembly code representative of machine code compiled based on obfuscated source code of a program, and a clustering function that can be programmed to cause a clustering tool to apply a clustering algorithm to a plurality of functions of the assembly code to cluster the plurality of functions and define a plurality of classes based on relationships between the plurality of functions. Each defined class can include a subset of functions of the plurality of functions. The plurality of classes can be stored in the memory as diagram modeling data. The instructions can include a modeling function that can be programmed to cause a modeling tool to generate a class diagram based on the diagram modeling data. The class diagram can characterize the obfuscated source code of the program.

In yet another example, a system can include memory to store machine readable instructions, and one or more processors to access the memory and execute the instructions. The instructions can include an interface that can be programmed to receive assembly code representative of machine code compiled based on obfuscated source code for a program, and a clustering function that can be programmed to cause a clustering tool to apply a clustering algorithm to a plurality of functions of the assembly code to cluster the plurality of functions and define a plurality of classes based on relationships between the plurality of functions. Each defined class can include a subset of functions of the plurality of functions. The plurality of classes can be stored in the memory as diagram modeling data. The instructions can include a modeling function that can be programmed to cause a modeling tool to generate a diagram model based on the diagram modeling data. The diagram model can characterize the obfuscated source code of the program. The instructions can include a library function that can be programmed to define a function library based on the diagram model. The function library can include a subset of functions from a respective class. The subset of functions of the function library can be accessible by one or more external programs.

### BRIEF DESCRIPTION OF THE DRAWINGS

FIG. 1 illustrates an example environment for reverse engineering executable code for obfuscated source code of a program.

FIG. 2 illustrates another example environment for reverse engineering executable code for obfuscated source code of a program.

FIGS. 3-8 illustrate an example of a diagram model.

FIGS. 9-12 illustrate another example of a diagram model.

FIGS. 13-16 illustrate an example of program source code.

FIG. 17 illustrates an example computer system that can be used to perform methods according to the systems and methods described herein.

FIG. 18 illustrates an example of a method for generating a diagram model based on executable code for obfuscated source code of a program.

FIG. 19 illustrates an example of a method for generating program source code based on a diagram model.

FIG. 20 illustrates an example of a method for defining a function library based on a diagram model.

### DETAILED DESCRIPTION

The present disclosure relates to systems and methods for reverse engineering executable code. As systems (e.g., programs, applications, software, etc.) age, there is an erosion of documentation, knowledge and support for these systems. This can leave a system running as a “black box” where the executable can still run, however, the inner-workings of the system are unknown. Resultantly, it can be difficult to make changes (e.g., updates, enhancements, etc.) to the system as there is a lack of knowledge as to how this system would respond to these changes, and whether new faults and/or old faults would emerge, impacting the system's performance or functionality.

Currently, machine code compiled based on source code (e.g., legacy source code) of a program can be reversed engineered using brute force hand techniques or using a standard decompiler to convert an executable binary into assembly code and then to low level code (e.g., low level C code). However, these techniques are highly inaccurate in reverse engineering source code and furthermore do not allow for converting executable binary compiled based on the source to diagram models. Nor do these existing techniques allow for generating modern program source code (e.g., object-oriented program source code) from diagram models generated based on machine code compiled based on source code.

According to the systems and methods provided herein a diagramming tool can be programmed to reverse engineer executable binaries for a program for which no source code is unavailable (e.g., lost). The diagramming tool can be programmed to provide system engineering artifacts (e.g., diagram models) that permits a human (e.g., a programmer) to understand the inner-workings of the program. The diagramming tool of the present disclosure can be programmed to reverse engineer the source code automatically (e.g., without requiring brute force hand techniques, or a decompiler) and further can be programmed to provide modern program source code (e.g., object-oriented program source code) from diagram models generated based on machine code compiled based on obfuscated source code.

In some examples, the diagramming tool can be programmed to receive from a disassembler assembly code representative of machine code compiled based on obfuscated source code. The diagramming tool can be programmed to extract a plurality of functions and a plurality of variables from the assembly code. The diagramming tool can be programmed to cause a clustering tool to evaluate the plurality of functions. The clustering tool can be programmed to evaluate the plurality of functions and group one or more functions of the plurality of functions into corresponding groups based on relationships between the plurality of functions. The diagramming tool can be programmed to define a class for each grouping of functions, and each defined class can include a subset of functions of the plurality of functions.

The diagramming tool can be programmed to evaluate the plurality of variables extracted from the assembly code to define a set of local variables for each class of the plurality of classes and a set of global variables for the plurality of classes. The diagramming tool can be programmed to cause a diagram model to be generated based on the plurality of classes and the sets of local and global variables for the plurality of classes. Examples of diagram models that can be caused to be generated by the diagramming tool can include a class diagram, a component diagram, a sequence diagram, and an activity diagram. Accordingly, the diagramming tool can be programmed to provide for reverse engineering of the executable code for the obfuscated source code (e.g., legacy source code) of the program into the diagram model without requiring brute force hand techniques, or a decompiler.

In some examples, the diagramming tool can be programmed to cause program source code using a human-readable programming language to be generated based on the diagram model. A compiled version of the program source code can be functionally equivalent to the obfuscated source code. As such, the diagramming tool of the present disclosure allows for generation of modern program source code and enables the program to run (or operate) on modern hardware while maintaining existing functionality and/or features. Furthermore, the diagramming tool allows for providing program source code that can be based on an object-oriented programming (OOP) paradigm, even if, the binary code and its obfuscated source code is not class oriented (e.g., not prepared according to the OOP paradigm). Thus, the diagramming tool can improve a quality of maintaining the program by providing source code that is based on the OOP paradigm. Moreover, the diagramming tool can be programmed to enhance a performance of one or more external programs by providing a library of functions that the one or more external programs can access and use to improve their features and performance. In some examples described herein, the diagramming tool can be implemented as a plugin and incorporated into an existing computer program. Examples of existing computer programs can include disassembler programs, web browsers, etc.

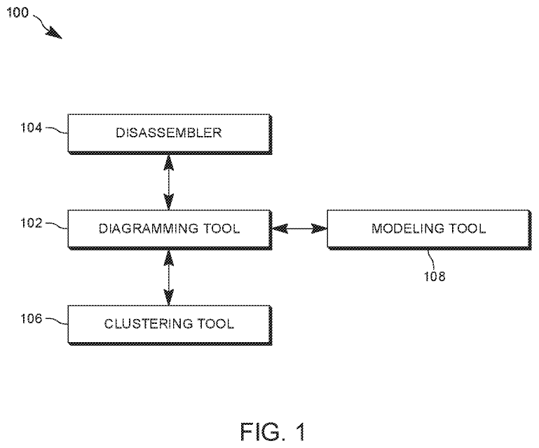

FIG. 1 illustrates an example environment 100 for reverse engineering executable code for obfuscated source code of a program. The environment 100 can include a diagramming tool 102. The diagramming tool 102 can be implemented as machine-readable instructions that can be stored in memory of a computer. The computer can include one or more processing units. The one or more processing units can be configured to access the memory and execute the machine-readable instructions stored in the memory, and thereby execute the diagramming tool 102. In some examples, the diagramming tool 102 can be implemented as a plugin and incorporated into a computer program. As an example, the computer program can be a disassembler program.

The diagramming tool 102 can be programmed to communicate with a disassembler 104. The disassembler 104 can be programmed to receive assembly code representative of machine code compiled based on obfuscated source code. The term “obfuscated”, as used herein, is a modifier relating to at least source code for which no support is being provided (e.g., by an organization, a developer, a technical team, etc.) such as legacy source code, for which a programming language may be unknown (e.g., in which programming language was the source code written), for which a purpose may be unknown (e.g., a functionality of a program for the source code), that is non-modernized source code, that had been automatically generated by a system (e.g., software), that is a version of software in its originally written language (e.g., typed completely or partially by a human into a computer), that is inherited from someone else, and/or that is inherited from an older version of the software. As such, obfuscated source code can include one or more applications that can have been developed with technologies beginning in the 1960s to date for which the original human-readable text has been lost or is otherwise unavailable.

In some examples, the disassembler 104 can be programmed to receive an executable binary (e.g., machine code) compiled (e.g., by a compiler) based on the obfuscated source code. The disassembler 104 can be programmed to disassemble (e.g., translate) the executable binary into assembly code. In other examples, the diagramming tool 102 can be programmed to receive the executable binary compiled based on the obfuscated source code and communicate the executable binary to the disassembler 104. The diagramming tool 102 can be programmed to cause (e.g., instruct) the disassembler 104 to translate the executable binary into the assembly code.

The diagramming tool 102 can be programmed to receive the assembly code and extract a plurality of functions and a plurality of variables from the assembly code. The diagramming tool 102 can be programmed to communicate with a clustering tool 106. The diagramming tool 102 can be programmed to communicate cluster processing data to the clustering tool 106. The cluster processing data can include processing information that can specify how the plurality of functions extracted from the assembly code can be processed and/or handled by the clustering tool 106. The diagramming tool 102 can be programmed to generate and communicate to the clustering tool 106 cluster tool input data that can include the plurality of functions extracted from the assembly code.

The diagramming tool 102 can be programmed to cause (e.g., instruct) the clustering tool 106 to evaluate the plurality of functions according to the cluster processing data. The clustering tool 106 can be programmed to evaluate the plurality of functions and group one or more functions of the plurality of functions into corresponding groups based on relationships between the plurality of functions. The clustering tool 106 can be implemented as a machine learning system, such a neural network or a rule-base system. The one or more functions can be grouped into a respective group based on a frequency that a given functions calls another function part of the respective group. As such, the grouping of the plurality of functions can be based on a function call frequency (e.g., how periodically respective functions call each other). Accordingly, functions that call other functions more frequently than other functions of the plurality of functions can be identified and grouped into groups.

In some examples, the diagramming tool 102 can be programmed to cause (e.g., instruct) the clustering tool 106 to apply a clustering algorithm to the plurality of functions to group the one or more functions into a plurality of groups according to the cluster processing data. The clustering algorithm can be programmed to group functions based on their interactions with each other, and based on an assumption that functions that call each other more frequently can be associated with each other. The clustering algorithm can be programmed to cluster the plurality of functions based on relationships between the pluralities of functions to form clusters of functions corresponding to the plurality of groups.

The clustering algorithm can be programmed to assign a flow value (e.g., flow data) to each function of each cluster of functions. The flow value can define a connectivity of a given function relative to one or more other functions of a respective cluster, and, in some examples, to one or more other functions of one or more different clusters. For example, a flow value of 0.5 assigned to a given function can be indicative that the given function is logically connected to a number of other functions (e.g., of a respective cluster of functions and/or one or more functions of one or more different clusters).

The clustering tool 106 can be programmed to generate cluster data. The cluster data can include cluster function information characterizing each cluster of functions (e.g., function connections) and/or flow value information for each function of each cluster of functions. The clustering tool 106 can be programmed to communicate the cluster data to the diagramming tool 102. The diagramming tool 102 can be programmed to define a plurality of classes based on the cluster data. As used herein, a “class” can refer to a template definition for methods (e.g., functions) and variables in a particular kind of object. Thus, an object can be a specific instance of a class. Each class can include a subset of functions of the plurality of functions that can have a high flow function (e.g., functions that are frequently called by each other in the given cluster of functions). The diagramming tool 102 can be programmed to store the plurality of classes in the memory as diagram modeling data.

In some examples, the diagramming tool 102 can be programmed to filter each cluster of functions to remove one or more functions based on the flow value information. As such, the diagramming tool 102 can be programmed to remove one or more functions from each cluster of functions based on the flow value assigned to a function of each cluster of functions. The diagramming tool 102 can be programmed to define a dynamic threshold for each cluster of functions based on the flow values associated with the functions of a respective cluster of functions. The diagramming tool 102 can be programmed to determine a mean of flow for each cluster of functions based on the flow value assigned to each function of each cluster of functions. The diagramming tool 102 can be programmed to determine a standard deviation of flow for each cluster of functions based on the flow mean and the flow value assigned to each function of each cluster of functions.

The diagramming tool 102 can be programmed to evaluate flow values assigned to each function of the cluster of functions to identify one or more functions that may be outside a given standard of deviations (e.g., two (2) standard deviations). The given standard of deviations can be referred to herein as “a dynamic threshold.” The diagramming tool 102 can be programmed to compare the flow values assigned to each function of each cluster of functions to a respective dynamic threshold. The diagramming tool 102 can be programmed to identify the one or more functions from each cluster of functions that may be outside a corresponding dynamic threshold.

The diagramming tool 102 can be programmed to remove and group the one or more functions of each cluster of functions that can be outside the corresponding dynamic threshold to define a utility class. Accordingly, low flow functions (e.g., functions that are not as frequently called by other functions in a given cluster of functions) can be grouped together to define the utility class. In some examples, the diagramming tool 102 can be programmed to evaluate the plurality of variables extracted from the assembly code to define a set of local variables for each class of the plurality of classes and a set of global variables that are accessible by each of the plurality of classes.

The diagramming tool 102 can be programmed to associate each variable with one or more functions of each subset of functions of each class based on relationships between each subset function of each class and each variable. Each variable that can be associated with a corresponding function of a respective class can define the set of local variables for the respective class. Each variable of the plurality of variables that can be associated with one or more corresponding functions from different classes can define the set of global variables. The set of local variables for each class and the set of global variables for the plurality of classes can be stored in the memory by the diagramming tool 102 as part of the diagram modeling data.

The diagramming tool 102 can be programmed to communicate the diagram modeling data to a modeling tool 108. In some examples, the diagramming tool 102 can be programmed to output the diagram modeling data in an Extensible Markup Language (XML) format. The modeling tool 108 can be programmed to generate a diagram model based on the diagram modeling data. In some examples, the diagramming tool 102 can be programmed to cause (e.g., instruct) the modeling tool 108 to generate the diagram model based on the diagram modeling data.

The diagramming tool 102 can be programmed to receive the diagram model and cause the diagram model to be outputted on a display (not shown in FIG. 1). The diagram model can provide a visual representation of the obfuscated source code (e.g., legacy source code) along with its main factors, roles, actions, artifacts and/or classes in order to understand (or better understand), alter, maintain, or document information about the obfuscated source code. Accordingly, the diagramming tool 102 can be programmed to provide for reverse engineering of the executable code for the obfuscated source code (e.g., legacy source code) of the program into the diagram model.

By use of the diagramming tool 102, obfuscated source code can be better understood (e.g., by recovering knowledge of the internal workings of the obfuscated source code), and the generated diagram models herein can provide insight into a structure, flow, and values within the executable binary (e.g., legacy machine code). Furthermore, the diagram models provided herein can be considered as recovered documentation for the obfuscated source code. Thus, the diagramming tool 102 provides for reverse engineering of the obfuscated source code without requiring that the executable binary is decompiled, or writing new source code based on the executable code for the obfuscated source code. Accordingly, executable binaries compiled based on obfuscated source code can be reversed engineered into system engineering artifacts (e.g., diagram models) without the need for a decompiler.

In some examples, the diagramming tool 102 can be programmed to communicate with a source code generator (not shown in FIG. 1). The diagramming tool 102 can be programmed to cause (e.g., instruct) the source code generator to generate program source code using a human-readable programming language based on the diagram model. Examples of the human-readable programming language can include, Java, C++, etc. A compiled version of the program source code can be functionally equivalent to the obfuscated source code (e.g., the legacy source code). By providing program source code that can be functionally equivalent to the obfuscated source code, the obfuscated source code can be sustained in a model based environment. In some examples, the diagramming tool 102 can cause the source code generator to generate object-oriented source code, even if, the obfuscated source code is written according to a different programming paradigm (e.g., declarative). Accordingly, the diagramming tool 102 can be programmed to provide code generation of modern object-oriented source code while retaining the functionality of the program for the obfuscated source code.

In some examples, the diagramming tool 102 can be programmed to evaluate the diagram model to define a function library and store the function library in the memory. The diagramming tool 102 can be programmed to identify one or more functions of the diagram model to define the function library. The function library can include a subset of functions of a respective class. The subset of functions of the function library can be accessible by one or more external programs. As such, the obfuscated source code can be leveraged by the diagramming tool 102 to provide a repository of functions for the one or more external programs. The one or more externals programs can be programmed to incorporate the one or more identified functions and enabled to perform one or more existing features (or functions) that previously were not possible by the one or more external programs. Accordingly, the diagramming tool 102 can enhance a performance of the one or more external programs by providing a function library with a subset of functions that had been recovered from the obfuscated source code.

Accordingly, the diagramming tool 102 allows for reverse engineering executable binaries compiled based on obfuscated source code (e.g., legacy source code) to provide system engineering artifacts (e.g., diagram models) that enables one to understand the inner-workings of a program for the obfuscated source code. The diagramming tool 102 allows for reverse engineering the obfuscated source code automatically (e.g., not requiring brute force hand techniques, or a decompiler) and generating program source code that conforms to particular coding standards (e.g., modern object-oriented source code. As such, the diagramming tool 102 allows for generation of program source code (e.g., modern program source code) that can run on modern hardware while maintaining existing functionality/features of the obfuscated source code.

Furthermore, the diagramming tool 102 allows for providing program source code that is based on an OOP paradigm, even if, the binary code and its obfuscated source code is not class oriented (e.g., not prepared according to the OOP paradigm). Thus, the diagramming tool 102 can improve a quality of maintaining the program by providing source code that is based on the OOP paradigm. Moreover, the diagramming tool 102 can enhance a performance of one or more other external programs by providing a library of functions that the one or more external programs can access and use to improve their features and performance.

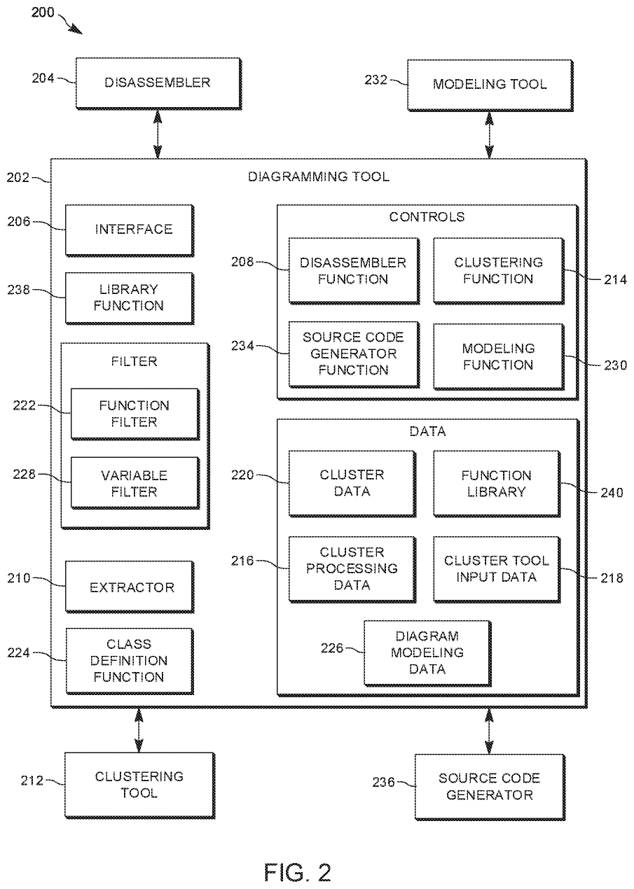

FIG. 2 illustrates another example environment 200 for reverse engineering executable code for obfuscated source code of a program. The environment 200 can include a diagramming tool 202. The diagramming tool 202 can correspond to the diagramming tool 102 in the example of FIG. 1. Therefore, reference is to be made to the example of FIG. 1 in the following description of the example of FIG. 2. The diagramming tool 202 can be implemented on a computer, such as a laptop computer, a desktop computer, a tablet computer, a workstation, or the like. The diagramming tool 202 can be implemented as machine-readable instructions that can be stored in memory of the computer. The memory can be implemented, for example, as a non-transitory computer storage medium, such as volatile memory (e.g., random access memory), non-volatile memory (e.g., a hard disk drive, a solid-state drive, flash memory or the like) or a combination thereof. The computer can include one or more processing units.

The one or more processing units can be configured to access the memory and execute the machine-readable instructions stored in the memory, and thereby execute the diagramming tool 202. The one or more processing units could be implemented, for example, as one or more processor cores. In the present example, although the components of the diagramming tool 202 are illustrated as being implemented on the same system, in other examples, the different components could be distributed across different systems (e.g., computers, devices, etc.) and communicate, for example, over a network (e.g., a wireless and/or wired network). In some examples, the diagramming tool 202 can be implemented as a plugin and incorporated into a computer program. As an example, the computer program can correspond to a disassembler program, as described herein.

The diagramming tool 202 can be programmed to communicate with a disassembler 204. The disassembler 204 can correspond to the disassembler 104 in the example of FIG. 1. The disassembler 204 can be programmed to receive assembly code representative of machine code compiled based on obfuscated source code. In some examples, the disassembler 204 can be programmed to receive an executable binary (e.g., machine code) compiled (e.g., by a compiler) based on the obfuscated source code. As an example, the disassembler 204 can correspond to an Interactive Disassembler (IDA), Radare2, Binary Ninja, Hopper, x64dbg, ODA Online Disassembler, Relyze, and the like. The disassembler 204 can be programmed to disassemble (e.g., translate) the executable binary into assembly code. In an example, the disassembler 204 can be programmed to output a graph description file (GDL) characterizing the assembly code. The GDL can graphically represent with blocks assembly instructions that can be implemented by the computer for each function and can include edges that can provide an indication of a flow from one block to another.

The diagramming tool 202 can be programmed to communicate via an interface 206 (e.g., an application program interface (API)) with the disassembler 204 to receive the assembly code (or the GDL). In some examples, the diagramming tool 202 can be programmed to receive the executable binary compiled based on the obfuscated source code. The diagramming tool 202 can include a disassembler function 208. The disassembler function 208 can be programmed to communicate the executable binary via the interface 206 to the disassembler 204 and cause (e.g., instruct) the disassembler 204 to translate the executable binary into the assembly code. Thus, in an example, the disassembler function 208 can instruct the disassembler 204 (e.g., by configuring parameters and/or settings of the disassembler 204) to translate the executable binary into the assembly code (or output the GDL).

The diagramming tool 202 can include an extractor 210. The extractor 210 can be programmed to extract a plurality of functions and a plurality of variables from the assembly code. The diagramming tool 202 can be programmed to communicate via the interface 206 with a clustering tool 212. The clustering tool 212 can correspond to the clustering tool 106 in the example of FIG. 1. In some examples, the diagramming tool 202 can include a clustering function 214. The clustering function 214 can be programmed to communicate to the clustering tool 212 via the interface 206 cluster processing data 216. The cluster processing data 216 can include processing information that can specify how the plurality of functions extracted from the assembly code can be processed and/or handled by the clustering tool 212. In an example, the clustering function 214 can be programmed to generate a script file. As an example, the script file can correspond to a batch file. In this example, the cluster processing data 216 can correspond to or form part of the script file.

The clustering function 214 can be programmed to generate cluster tool input data 218 that can include the plurality of functions extracted from the assembly code (or the GDL). The cluster tool input data 218 can be generated by the clustering function 214 in a file format that can be read (e.g., understood) by the clustering tool 212. As such, the clustering function 214 can be programmed to provide the cluster tool input data 218 in a file format that can be compatible with the clustering tool 212. In some examples, the file format of the clustering tool input data 218 can include a minimal link list format (e.g., .txt extension).a Pajket format (e.g., .net extension), a comma separated values form (e.g., .csv extension), and the like. In some examples, the cluster tool input data 218 can include one or more vertices and one or more edges. The one or more vertices and/or the one or more vertices can be associated with one or more functions of the plurality of functions extracted from the assembly code. In some examples, the edges can be weighted or unweighted.

The clustering function 214 can be programmed to cause (e.g., instruct) the clustering tool 212 to evaluate the plurality of functions according to the cluster processing data 216. The clustering tool 212 can be programmed to evaluate the plurality of functions and group one or more functions of the plurality of functions into corresponding groups based on relationships between the plurality of functions. The one or more functions can be grouped into a respective group based on a frequency that a given functions calls another function part of the respective group. As such, the grouping of the plurality of functions can be based on a function call frequency (e.g., how periodically respective functions call each other). Accordingly, functions that call other functions more frequently than other functions of the plurality of functions can be identified and grouped into groups.

In some examples, the clustering function 214 can be programmed to cause (e.g., instruct) the clustering tool 212 to apply a clustering algorithm to the plurality of functions to group the one or more functions into a plurality of groups according to the cluster processing data 216. The clustering algorithm can be programmed to group functions based on their interactions with each other, and based on an assumption that functions that call each other more frequently are associated with each other. As an example, the clustering algorithm can correspond to a network clustering algorithm such as InfoMap, Markov Clustering, or an algorithm that can handle unweighted edges (e.g., unweighted direction edges). The clustering algorithm can be programmed to cluster the plurality of functions based on relationships between the pluralities of functions to form clusters of functions corresponding to the plurality of groups. For example, functions that frequently call one or more other functions can be clustered (e.g., grouped) together to form a corresponding cluster of functions. Thus, each cluster of functions can include a plurality of functions that can have a close connectivity in relation to each other.

The clustering algorithm can be programmed to assign a flow value to each function of each cluster of functions. The flow value can define a connectivity of a given function relative to one or more other functions of a respective cluster, and, in some examples, to one or more other functions of one or more different cluster of functions. As such, as an example, a function assigned a greater flow value within a cluster of functions can be indicative that the function is connected to a greater number of functions within the cluster of functions (and/or functions of different clusters) relative to another function assigned a lower flow value within the cluster of functions.

The clustering tool 212 can be programmed to generate cluster data 220. The cluster data 220 can include cluster function information characterizing each cluster of functions (e.g., function connections) and flow value information for each function of each cluster of functions. The cluster data 220 can be generated by the clustering tool 212 in a file format that can be read (e.g., understood) by the diagramming tool 202.

In some examples, the file format of the cluster data 220 can include a map format (e.g., .map extension). The map format can be represented as a text file. Thus, the text file can include the cluster function information and the flow value information. The clustering tool 212 can be programmed to communicate the cluster data 220 via the interface 206 to the diagramming tool 202, which can be programmed to store the cluster data 220 in the memory.

The diagramming tool can include a function filter 222. The function filter 222 can be programmed to filter each cluster of functions to remove one or more functions based on the flow value information from the cluster data 220. As such, the function filter 222 can be programmed to remove one or more functions from each cluster of functions based on a flow value assigned to a function of each cluster of functions. The function filter 222 can be programmed to define a dynamic threshold for each cluster of functions. The function filter 222 can be programmed to determine a mean of flow for each cluster of functions based on the flow values associated with the functions of a respective cluster of functions. The mean of flow (or flow mean) can define an average function connectivity for each cluster of functions (e.g., an average number of connections between the functions of the cluster of functions). The function filter 222 can be programmed to determine a standard deviation of flow for each cluster of functions based on the flow mean and the flow value assigned to each function of each cluster of functions. The standard deviation of flow (or flow deviation) can define a function connectivity deviation range for each cluster of functions.

The function filter 222 can be programmed to evaluate flow values assigned to each function of the cluster of functions to identify one or more functions that may be outside a given standard of deviations (e.g., two (2) standard deviations) of the function connectivity range. The given standard of deviations can be referred to herein as “a dynamic threshold.” Thus, the function filter 222 can be programmed to compare the flow values assigned to each function of each cluster of functions to a respective dynamic threshold. The function filter 222 can be programmed to identify the one or more functions from each cluster of functions that may be outside a corresponding dynamic threshold.

The function filter 222 can be programmed to remove and group the one or more functions of each cluster of functions that can be outside the corresponding dynamic threshold to define a utility class. In an example, the utility class can include one or more functions that may be static functions (e.g., static methods), and thus cannot be instantiated. In some examples, the utility class can include one or more related functions that can be used across a plurality of cluster functions. Accordingly, low flow functions (e.g., functions that are not as frequently called by other functions in a given cluster of functions) can be grouped together to define the utility class.

The diagramming tool 202 can include a class definition function 224. The class definition function 224 can be programmed to define a plurality of classes based on the filtered cluster data. Each class can include a subset of functions of the plurality of functions that can have a high flow function (e.g., functions that are frequently called by each other in the given cluster of functions). The class definition function 224 can be programmed to store the plurality of classes in the memory as diagram modeling data 226.

The diagramming tool 202 can include a variable filter 228. The variable filter 228 can be programmed to evaluate the plurality of variables extracted by the extractor 210 to define a set of local variables for each class of the plurality of classes and a set of global variables for the plurality of classes. The variable filter 228 can be programmed to associate each variable with one or more functions of each subset of functions of each class based on relationships between each subset function of each class and each variable. For example, a variable that can be called by one or more subset of functions of a given class can be associated by the variable filter 228 with the given class, and thereby the one or more subset of functions of the given class. Each variable that can be associated with a corresponding function of a respective class can define the set of local variables for the respective class.

Accordingly, when a variable is called by functions from a similar class, then the variable can be identified as a class level variable. Each variable of the plurality of variables that can be associated with one or more corresponding functions from different classes can define the set of global variables. Thus, if the variable is called by functions from different classes, then the variable can be identified as a global level variable. The set of local variables for each class and the set of global variables for the plurality of classes can be stored in the memory as part of the diagram modeling data 226.

The diagramming tool 202 can include a modeling function 230. The modeling function 230 can be programmed to evaluate the diagram modeling data 226 and output the data in a file format that can be read (e.g., understood) by a modeling tool 232. The modeling tool 232 can correspond to the modeling tool 108 in the example of FIG. 1. In some examples, the modeling function 230 can be programmed to output the data in an XML format. Thus, the modeling function 230 can be programmed to encode the diagram modeling data 226 in an XML file format. The modeling function 230 can be programmed to communicate via the interface 206 the diagram modeling data 226 to the modeling tool 232. As an example, the modeling tool 232 can include Enterprise Architect By Sparx Systems, PTC Integrity, Rational Rhapsody, Cameo No Magic, and the like.

The modeling tool 232 can be programmed to generate a diagram model based on the diagram modeling data 226. In some examples, the modeling function 230 can be programmed to cause (e.g., instruct) the modeling tool 232 to generate the diagram model based on the diagram modeling data 226. Examples of diagram models that can be generated based on the diagram modeling data 226 can include a class diagram, a component diagram, a sequence diagram, and an activity diagram. In some examples, the modeling tool 232 can be programmed to generate Unified Modeling Language (UML) diagrams based on the diagram modeling data 226. As such, the diagram model can include structural and/or behavioral diagrams.

The diagramming tool 202 can be programmed to receive the diagram model and cause the diagram model to be outputted on a display (not shown in FIG. 2). The diagram model can provide a visual representation of the obfuscated source code (e.g., legacy source code) along with its main factors, roles, actions, artifacts and/or classes in order to understand (or better understand), alter, maintain, or document information about the obfuscated source code.

Accordingly, the diagramming tool 202 can be programmed to provide for reverse engineering of the executable code for the obfuscated source code (e.g., legacy source code) of the program into the diagram model. By use of the diagramming tool 202, obfuscated source code can be better understood (e.g., by recovering knowledge of the internal workings of the obfuscated source code), and the generated diagram models herein can provide insight into a structure, flow, and values within the executable binary (e.g., legacy machine code). Furthermore, the diagram models provided herein can be considered as recovered documentation for the obfuscated source code. Thus, the diagramming tool 202 provides for reverse engineering of the obfuscated source code without requiring that the obfuscated executable binary is decompiled, or writing new source code based on the executable code for the obfuscated source code. Accordingly, executable binaries compiled based on obfuscated source code can be reversed engineered into system engineering artifacts (e.g., diagram models) without the need for a decompiler.

In some examples, the diagramming tool 202 can include a source code generator function 234. The source code generator function 234 can be programmed to communicate via the interface 206 with a source code generator 236. The source code generator function 234 can be programmed to cause (e.g., instruct) the source code generator 236 to generate program source code using a human-readable programming language based on the diagram model. Examples of the human-readable programming language can include, Java, C++, etc.

A compiled version of the program source code can be functionally equivalent to the obfuscated source code (e.g., the legacy source code). An example of the source code generator 236 can include a diagram modeling tool, for example, a UML modeling tool, which can generate the program source code based on visual design application models (e.g., the diagram model). Accordingly, the diagramming tool 202 can generate the program source code based on diagram models characterizing the obfuscated source code. By providing program source code that can be functionally equivalent to the obfuscated source code, the obfuscated source code can be sustained in a model based environment.

The diagramming tool 202 can cause the source code generator 236 to generate object-oriented source code, even if, the obfuscated source code is written according to a different programming paradigm. For example, if the obfuscated source code is written according to a declarative programming paradigm, the diagramming tool 202 can cause the source code generator 236 to generate object-oriented program source code. Thus, the program source code can be generated according to an object oriented programming paradigm. In some examples, the diagramming tool 202 can cause the source code generator 236 to generate the program source code with a mixture of programming paradigms (e.g., declarative, imperative (e.g., procedural, object-oriented, etc.), etc.). Accordingly, the diagramming tool 102 can be programmed to provide code generation of modern object-oriented source code while retaining the functionality of the program for the obfuscated source code.

In some examples, the diagramming tool 202 can include a library function 238. The library function 238 can be programmed to evaluate the diagram model to define a function library 240 and store the function library 240 in the memory. The library function 238 can be programmed to identify one or more functions of the diagram model. Thus, the function library 240 can include a subset of functions of a respective class. The subset of functions of the function library 240 can be accessible by one or more external programs. As such, the obfuscated source can be leveraged to provide a repository of functions extracted from the obfuscated source code for the one or more external programs.

In some examples, the library function 238 can be programmed to monitor for a function request from the one or more external programs. In an example, the one or more external programs can be programmed to communicate via the interface 206 with the diagramming tool 202. In response to detecting (or receiving) the function request, the library function 238 can evaluate to the function request and identify one or more functions of the subset of functions in the function library 240. The library function 238 can retrieve the identified one or more functions and provide the one or more identified functions to the one or more external programs.

The one or more externals programs can be programmed to incorporate the one or more identified functions and enabled to perform one or more existing features that previously were not possible by the one or more external programs. Accordingly, the diagramming tool 202 can enhance a performance of the one or more external programs by providing a function library with a subset of functions that had been recovered from the obfuscated source code.

Accordingly, the diagramming tool 202 allows for reverse engineering executable binaries compiled based on obfuscated source code (e.g., legacy source code) to provide system engineering artifacts (e.g., diagram models) that enables one to understand the inner-workings of a program for the obfuscated source code. The diagramming tool 202 allows for generation of program source code (e.g., modern program source code) that can run on modern hardware while maintaining existing functionality/features of the obfuscated source code.

Furthermore, the diagramming tool 202 allows for providing program source code that is based on an object-oriented programming (OOP) paradigm, even if, the binary code and its obfuscated source code is not class oriented (e.g., not prepared according to the OOP paradigm). Thus, the diagramming tool 202 can improve a quality of maintaining the program by providing source code that is based on the OOP paradigm. Moreover, the diagramming tool 202 can enhance a performance of one or more other external programs by providing a library of functions that the one or more external programs can access and use to improve their features and performance.

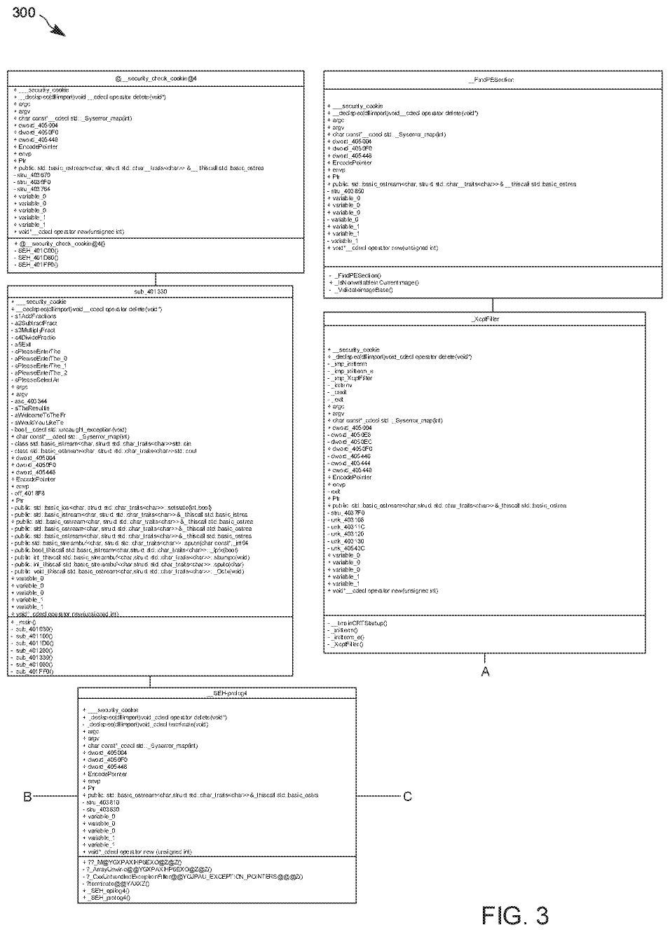

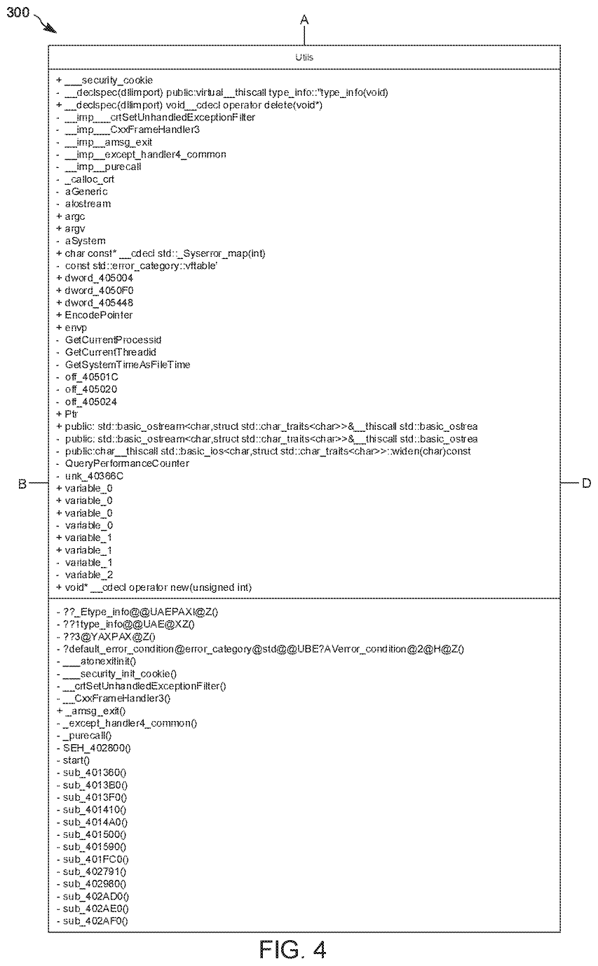

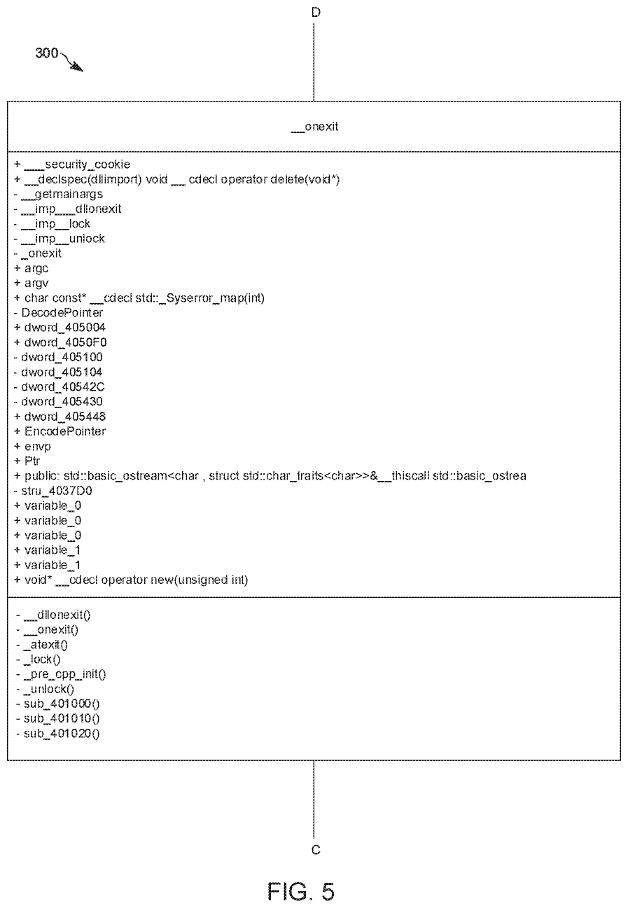

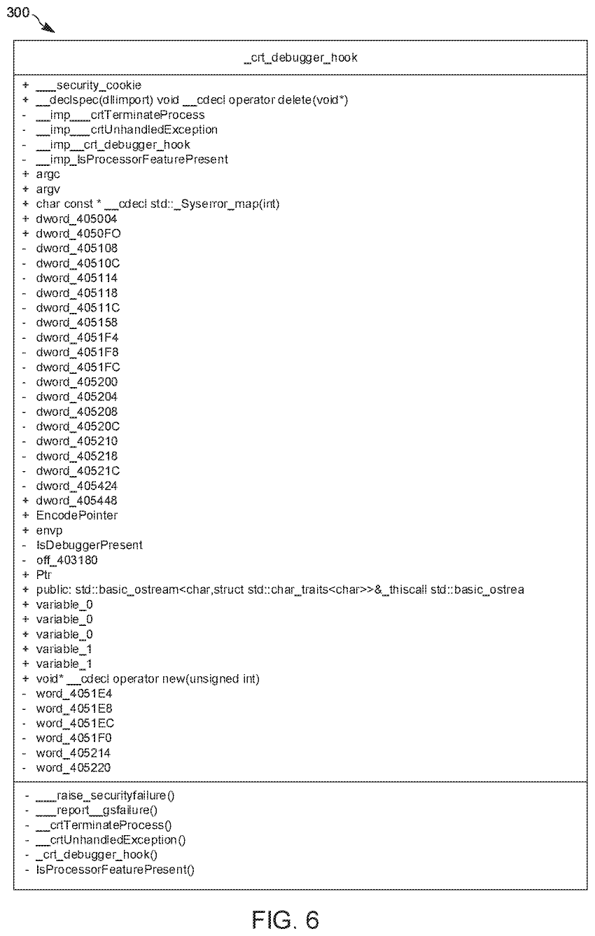

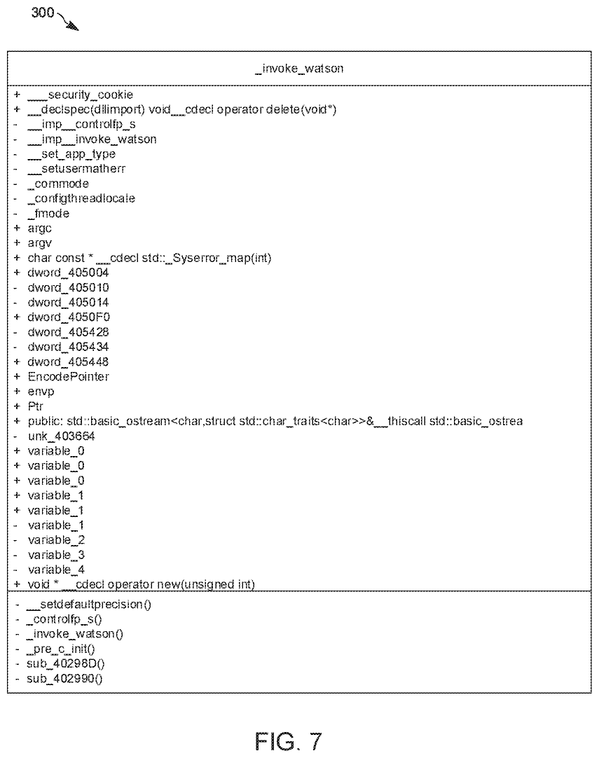

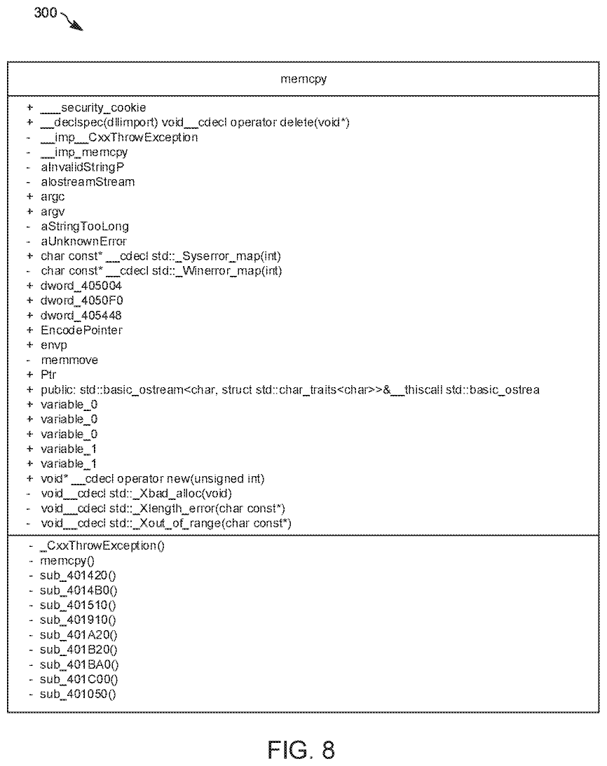

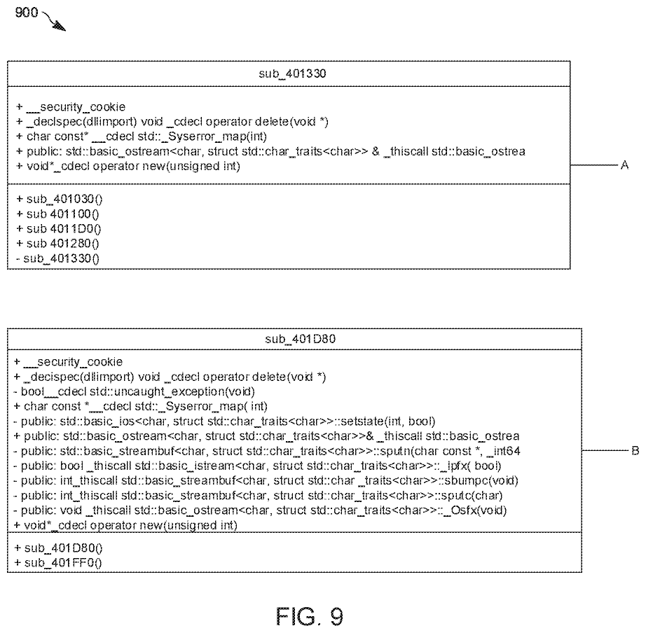

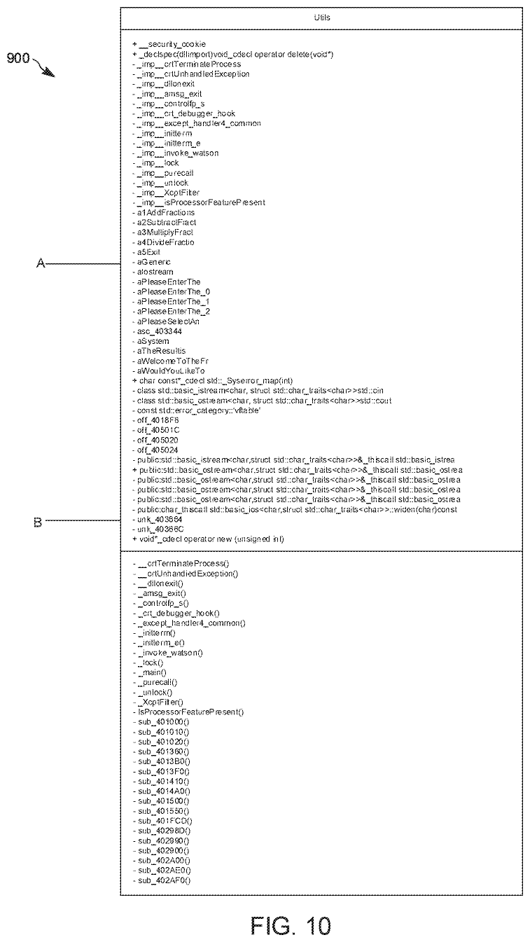

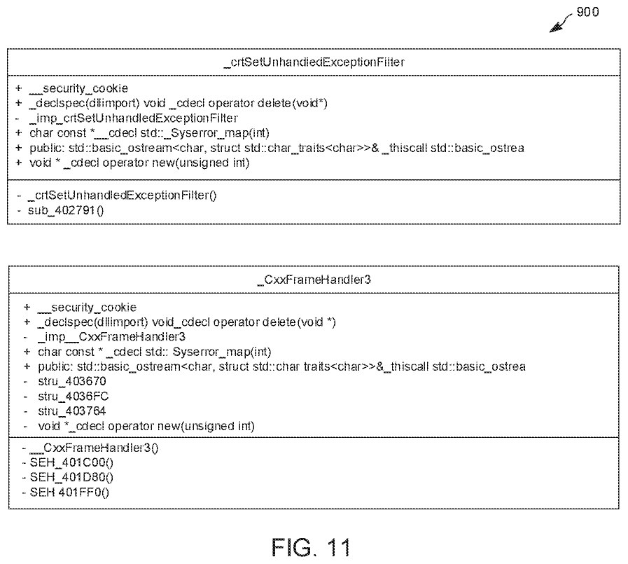

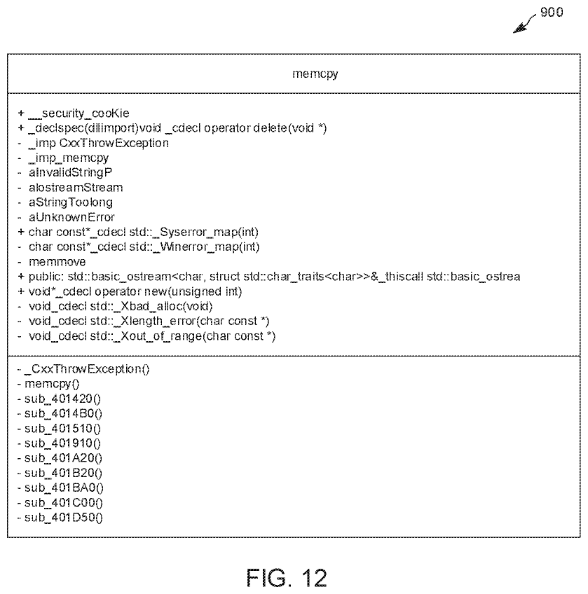

FIGS. 3-12 illustrate example diagram models that can be generated by a modeling tool (e.g., the modeling tool 108 or the modeling tool 232), e.g., in response to a diagramming tool (e.g., the diagramming tool 102 or the diagramming tool 202). FIGS. 3-8 illustrate a class diagram 300 that can be generated by the modeling tool. The class diagram 300 can include a plurality of classes including a utility class, and a set of local variables for each class and a set of global variables for the plurality of classes. In some examples, the class diagram 300 can be filtered by the diagramming tool to remove one or more classes to ease understanding of the class diagram 300 and correspond the obfuscated source code of the program. FIGS. 9-12 illustrate an example of a class diagram 900 that has been filtered to remove one or more system level type classes. In some examples, the diagramming tool can be programmed to filter diagram modeling data (e.g., the diagram modeling data 226) based on filtering criteria (e.g., based on a pattern matching done by the disassembler 204, which can recognize system calls and library functions), which can be user provided, to generate a filter class diagram, such as the class diagram 900.

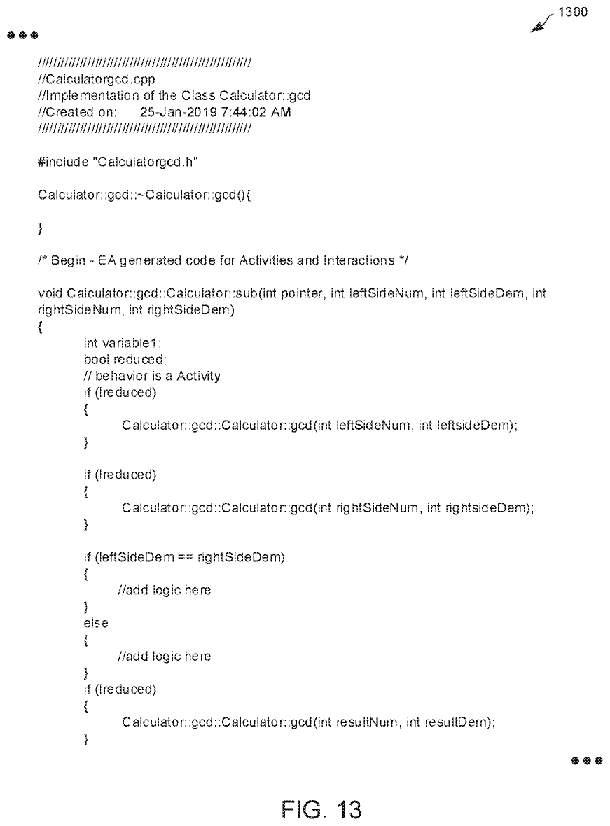

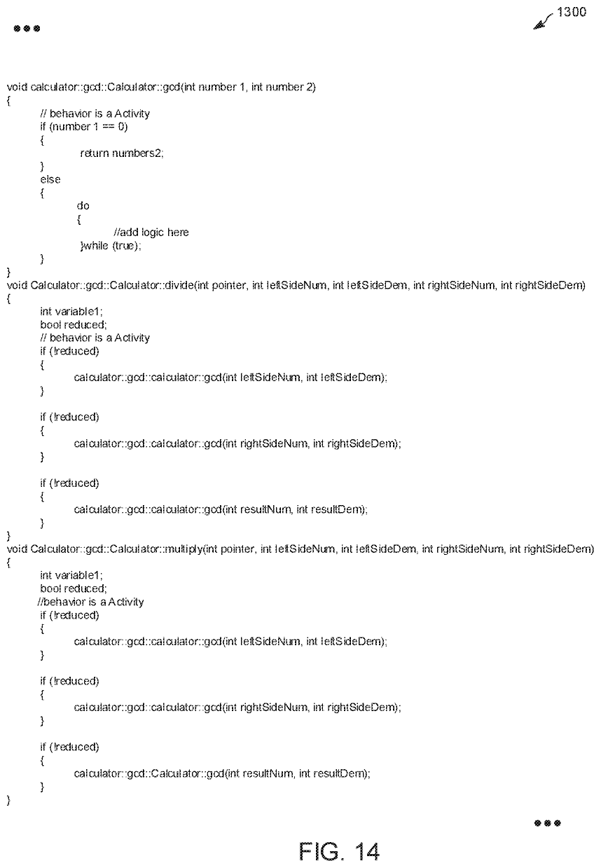

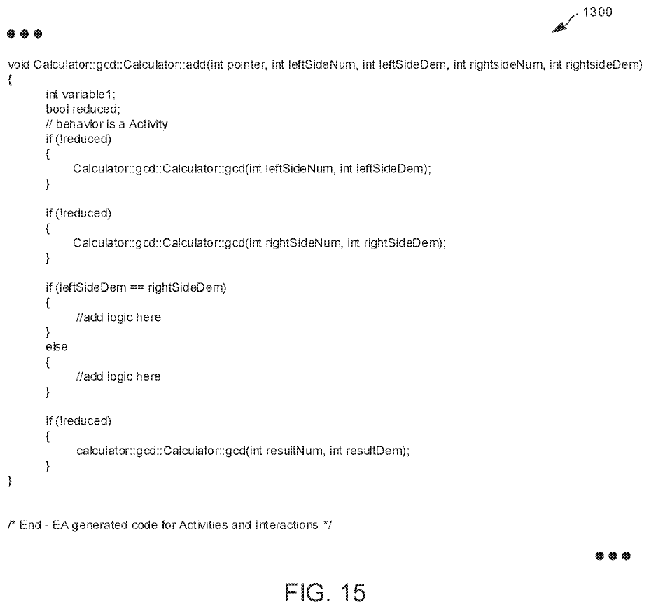

FIGS. 13-16 illustrate an example of program source code 1300 that can be generated by a source code generator (e.g., the source code generator 236), e.g., in response to a diagramming tool (e.g., the diagramming tool 102 or the diagramming tool 202). The program source code 1300 of FIGS. 13-16 can be a portion of the program source code that can be generated based on a diagram model (e.g., the class diagram 900). The program source code 1300 can be representative of a calculator program. The program source code 1300 can be stored in a given compiler file format that can be interpreted by a compiler to generate representative lower level source code that can be executed by the processor to run the program. For example, the program source code 1300 can include one or more declarations associated with a given class of the plurality of classes (e.g., as shown in the class diagram 900) that can be stored in a given file format (e.g., a .h file format), and one or more definitions associated with the given class that can be stored in another file format (e.g., a .cpp file format).

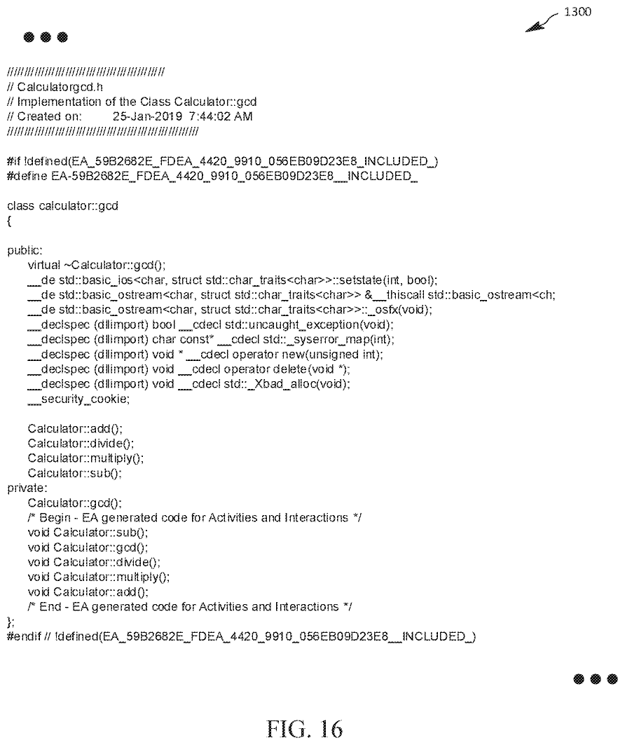

The compiler can be configured to read one or more .cpp files and include one or more .h files for the program source code 1300 to write an object file. FIGS. 13-15 illustrate the contents of a given file (e.g., .cpp file) for a class of the program source code 1300, and FIG. 16 illustrates the content of another file (e.g., .h file) for the class of the program source code 1300. For example, the .cpp file of FIGS. 13-15 illustrate functions for the calculator program (e.g., such as addition, division, multiplication, etc.), and the .h file in FIG. 16 illustrates header files for the .cpp file and includes definition of the functions and variables. Accordingly, the diagramming tool can generate the program source code (e.g., the program source code 1300 of FIGS. 13-16) based on diagram models characterizing the obfuscated source code.

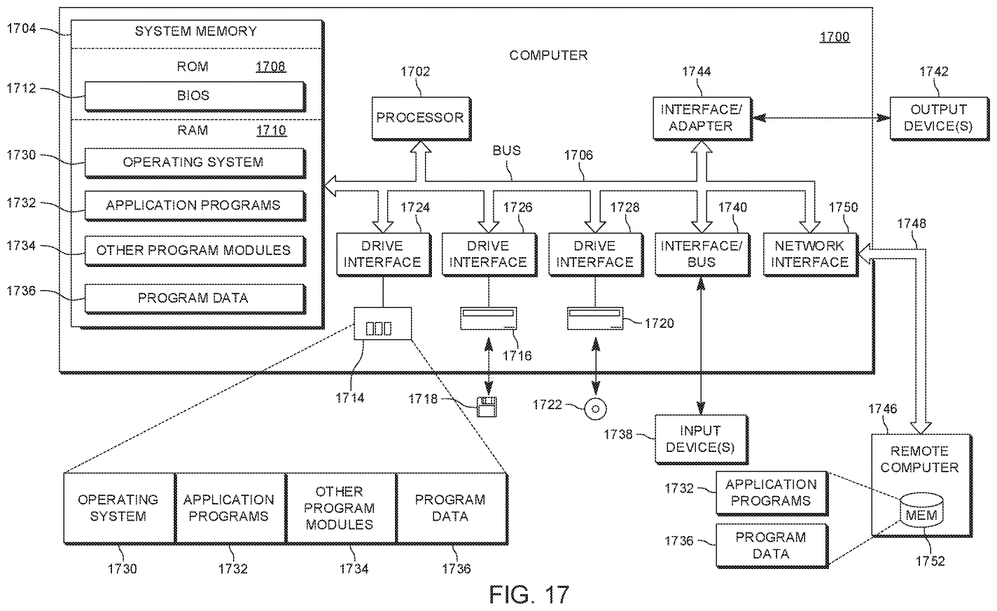

FIG. 17 depicts an example of a computer system 1700 that can be used to perform methods according to an embodiment of the invention, such as including providing system engineering artifacts (e.g., diagram models) based on executable binaries for a program for which no source code may be available (e.g., the source code is lost). Computer system 1700 can be implemented on one or more general purpose networked computer systems, embedded computer systems, routers, switches, server devices, client devices, various intermediate devices/nodes or stand-alone computer systems. Additionally, computer system 1700 can be implemented on various mobile clients such as, for example, a personal digital assistant (PDA), laptop computer, pager, and the like, provided it includes sufficient processing capabilities to perform the functions disclosed herein.

Computer system 1700 includes processing unit 1702, system memory 1704, and system bus 1706 that couples various system components, including the system memory, to processing unit 1702. Dual microprocessors and other multi-processor architectures also can be used as processing unit 1702. System bus 1706 may be any of several types of bus structure including a memory bus or memory controller, a peripheral bus, and a local bus using any of a variety of bus architectures. System memory 1704 includes read only memory (ROM) 1708 and random access memory (RAM) 1710. A basic input/output system (BIOS) 1712 can reside in ROM 1708 containing the basic routines that help to transfer information among elements within computer system 1700.

Computer system 1700 can include a hard disk drive 1714, magnetic disk drive 1716, e.g., to read from or write to removable disk 1718, and an optical disk drive 1720, e.g., for reading CD-ROM disk 1722 or to read from or write to other optical media. Hard disk drive 1714, magnetic disk drive 1716, and optical disk drive 1720 are connected to system bus 1706 by a hard disk drive interface 1724, a magnetic disk drive interface 1726, and an optical drive interface 1728, respectively. The drives and their associated computer-readable media provide nonvolatile storage of data, data structures, and computer-executable instructions for computer system 1700. Although the description of computer-readable media above refers to a hard disk, a removable magnetic disk and a CD, other types of media that are readable by a computer, such as a thumb drive, magnetic cassettes, flash memory cards, digital video disks and the like, in a variety of forms, may also be used in the operating environment; further, any such media may contain computer-executable instructions for implementing one or more parts of the present disclosure.

A number of program modules may be stored in drives and RAM 1710, including operating system 1730, one or more application programs 1732, other program modules 1734, and program data 1736. The application programs 1732 and program data 1736 can include functions and methods that can be programmed to provide a diagramming tool (e.g., the diagramming tool 102 or the diagramming tool 202, such as shown and described herein). The application programs 1732 and program data 1736 can include functions and methods programmed to control (e.g., instruct) one or more additional elements described herein (e.g., the disassembler 104 of FIG. 1 or 204 of FIG. 2, the clustering tool 106 of FIG. 1 or 212 of FIG. 2, the modeling tool 108 of FIG. 1 or 230 of FIG. 2, and/or the source code generator 236 of FIG. 2).

A user may enter commands and information into computer system 1700 through one or more input devices 1738, such as a pointing device (e.g., a mouse, touch screen), keyboard, microphone, joystick, game pad, scanner, and the like. For instance, the user can employ input device 1738 to provide obfuscated source code. These and other input devices are often connected to the processing unit 1702 through a corresponding port interface 1740 that is coupled to the system bus 1706, but may be connected by other interfaces, such as a parallel port, serial port, or universal serial bus (USB). One or more output devices 1742 (e.g., display, a monitor, printer, projector, or other type of displaying device) is also connected to system bus 1706 via interface 1744, such as a video adapter. As described herein, a diagramming tool can be programmed provide a diagram model on the one or more output devices 1742.

Computer system 1700 may operate in a networked environment using logical connections to one or more remote computers, such as remote computer 1746. Remote computer 1746 may be a workstation, computer system, router, peer device, or other common network node, and typically includes many or all the elements described relative to computer system 1700. The logical connections, schematically indicated at 1748, can include a local area network (LAN) and a wide area network (WAN). When used in a LAN networking environment, computer system 1700 can be connected to the local network through a network interface or adapter 1750. When used in a WAN networking environment, computer system 1700 can include a modem, or can be connected to a communications server on the LAN. The modem, which may be internal or external, can be connected to system bus 1706 via an appropriate port interface. In a networked environment, application programs 1732 or program data 1736 depicted relative to computer system 1700, or portions thereof, may be stored in a remote memory storage device 1752.

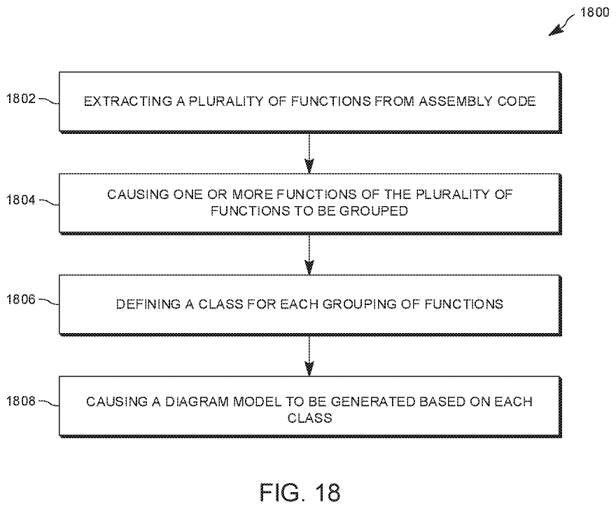

In view of the foregoing structural and functional features described above, can example method will be better appreciated with references to FIGS. 18-20. While, for purposes of simplicity of explanation, the example methods of FIGS. 18-20 are shown and described as executing serially, it is to be understood and appreciated that the present example is not limited by the illustrated order, as some actions could in other examples occur in different orders, multiple times and/or concurrently from that shown and described herein.

FIG. 18 illustrates an example of a method 1800 for generating a diagram model based on executable code for obfuscated source code of a program. The method 1800 can be implemented by the diagramming tool 102 in the example of FIG. 1 or the diagramming tool 202 in the example of FIG. 2, e.g., on a computer (e.g., the computer system 1700). The method 1800 can begin at 1802 by extracting a plurality of functions from assembly code representative of machine code compiled based on obfuscated source code of a program (e.g., with the extractor 210 of FIG. 2). At 1804, causing one or more functions of the plurality of functions to be grouped based on relationships between the plurality of functions (e.g., with the clustering function 214 of FIG. 2). At 1806, defining a class for each grouping of functions (e.g., with the class definition function 224 of FIG. 2). Each class can include a subset of functions of the plurality of functions. At 1808, causing a diagram model (e.g., the class diagram 300 or the class diagram 900) to be generated based on the plurality of classes (e.g., with the modeling function 230 of FIG. 2). The diagram model can characterize the obfuscated source code of the program.

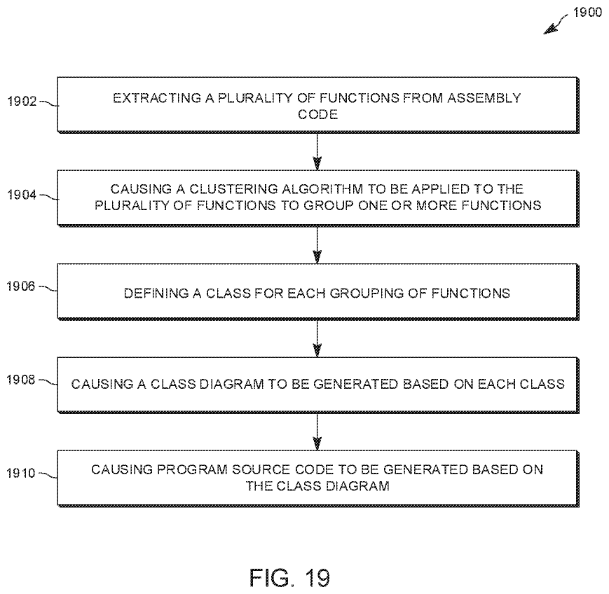

FIG. 19 illustrates an example of a method 1900 for generating program source code based on a diagram model. The method 1900 can be implemented by the diagramming tool 102 in the example of FIG. 1 or the diagramming tool 202 in the example of FIG. 2, e.g., on a computer (e.g., the computer system 1700). The method 1900 can begin at 1902 by extracting a plurality of functions from assembly code representative of machine code compiled based on obfuscated source code of a program (e.g., with the extractor 210 of FIG. 2). At 1904, causing to apply a clustering algorithm to the plurality of functions to group one or more functions based on relationships between the plurality of functions (e.g., with the clustering function 214 of FIG. 2).

At 1906, defining a class for each grouping of functions (e.g., with the class definition function 224 of FIG. 2). Each class can include a subset of functions of the plurality of functions. At 1908, causing a class diagram (e.g., the class diagram 300 or the class diagram 900) to be generated based on the plurality of classes (e.g., with the modeling function 230 of FIG. 2). The class diagram can characterize the obfuscated source code. At 1910, causing program source code (e.g., the program source code 1300) to be generated based on the class diagram (e.g., with the source code generator function 234 of FIG. 2). A compiled version of the program source code can be functionally equivalent to the obfuscated source code (e.g., legacy source code) of the program.

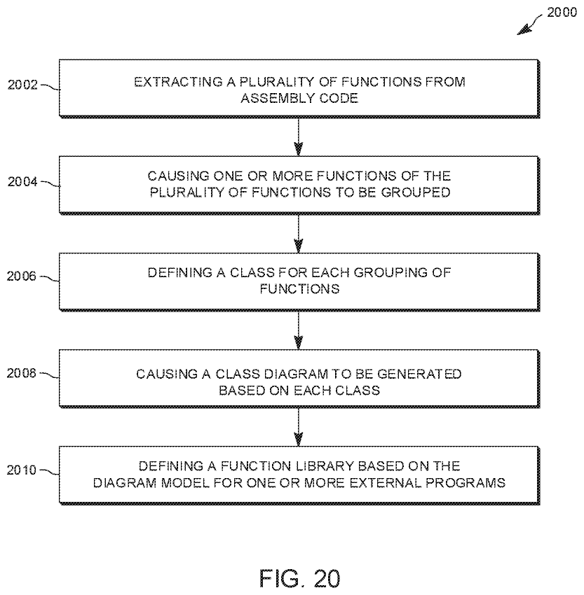

FIG. 20 illustrates an example of a method 2000 for defining a function library based on a diagram model. The method 2000 can be implemented by the diagramming tool 102 in the example of FIG. 1 or the diagramming tool 202 in the example of FIG. 2, e.g., on a computer (e.g., the computer system 1700). The method 2000 can begin at 2002 by extracting a plurality of functions from assembly code representative of machine code compiled based on obfuscated source code of a program (e.g., with the extractor 210 of FIG. 2). At 2004, causing one or more functions of the plurality of functions to be grouped based on relationships between the plurality of functions (e.g., with the clustering function 214 of FIG. 2). At 2006, defining a class for each grouping of functions (e.g., with the class definition function 224 of FIG. 2). Each class can include a subset of functions of the plurality of functions.

At 2008, causing a diagram model (e.g., the class diagram 300 or the class diagram 900) to be generated based on the plurality of classes (e.g., with the modeling function 230 of FIG. 2). The diagram model can characterize the obfuscated source code of the program. At 2010, defining a function library (e.g., the function library 240) based on the diagram model (e.g., with the library function 238 of FIG. 2). The function library can include a subset of functions from a respective class. The subset of functions of the function library can be accessible by one or more external programs.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A computer implemented method comprising:
extracting a plurality of functions from assembly code representative of machine code compiled based on obfuscated source code of a program;
causing one or more functions of the plurality of functions to be grouped based on relationships between the plurality of functions;
defining a class for each grouping of functions, wherein each class comprises a subset of functions of the plurality of functions; and
causing a diagram model to be generated based on the plurality of classes, wherein the diagram model characterizes the obfuscated source code of the program.

2. The computer implemented method of claim 1, wherein the causing the one or more functions of the plurality of functions to be grouped comprises applying a clustering algorithm to the plurality of functions to group the one or more functions.

3. The computer-implemented method of claim 2, further comprising:
filtering each grouping of functions according to a dynamic threshold to remove one or more functions; and
grouping the removed one or more functions to define a utility class, the diagram model being further generated based on the utility class.

4. The computer implemented method of claim 3, further comprising:
extracting a plurality of variables from the assembly code; and
associating each variable of the plurality of variables with one or more functions of the plurality of functions based on relationships between each function of the plurality of functions and each variable.

5. The computer implemented method of claim 4,
wherein each variable of the plurality of variables that is associated with each function of the plurality of functions from a respective class defines a set of local variables for the respective class,
wherein each variable of the plurality of variables that is associated with different functions of the plurality of functions from different respective classes of the plurality of classes defines a set of global variables, and
wherein the diagram model is further generated based on each set of local variables and each set of global variables.

6. The computer-implemented method of claim 5, wherein the class diagram characterizes the obfuscated source code by identifying each class and each set of local and global variables for the obfuscated source code.

7. The computer-implemented method of claim 1, wherein the one or more functions are grouped based on a frequency that a respective function calls another function of the plurality of functions.

8. The computer-implemented method of claim 7, further comprising causing an executable binary compiled based on the obfuscated source code to be dissembled to generate the assembly code.

9. The computer-implemented method of claim 1, wherein the diagram model comprises one of a class diagram, a component diagram, a sequence diagram, an activity diagram, and combinations thereof.

10. The computer-implemented method of claim 1, further comprising generating program source code using a human-readable programming language based on the diagram model, wherein a compiled version of the program source code is functionally equivalent to the obfuscated source code.

11. The computer-implemented method of claim 1, further comprising defining a function library based on the diagram model, the function library comprising a subset of functions from a respective class, wherein the subset of functions of the function library is accessible by one or more external programs.

12. A system comprising:
memory to store machine readable instructions and data; and
one or more processors to access the memory and execute the instructions, the instructions comprising:
an interface programmed to receive assembly code representative of machine code compiled based on obfuscated source code of a program;
a clustering function programmed to cause a clustering tool to apply a clustering algorithm to a plurality of functions of the assembly code to cluster the plurality of functions and define a plurality of classes based on relationships between the plurality of functions, wherein each class comprises a subset of functions of the plurality of functions, the plurality of classes being stored in the memory as diagram modeling data;
a modeling function programmed to cause a modeling tool to generate a class diagram based on the diagram modeling data, wherein the class diagram characterizes the obfuscated source code of the program.

13. The system of claim 12, wherein the instructions further comprise a function filter programmed to filter each grouping of functions according to a dynamic threshold to remove one or more functions, and group the removed one or more functions to define a utility class, the class diagram being further generated based on the utility class.

14. The system of claim 12, wherein the instructions further comprise an extractor programmed to extract a plurality of functions and a plurality of variables from the assembly code, and associating each variable of the plurality of variables with one or more functions of the plurality of functions based on relationships between each function of the plurality of functions and each variable, wherein the class diagram is further generated based on the association.

15. The system of claim 14, wherein the instructions further comprise a disassembler function programmed to cause a disassembler to disassemble an executable binary compiled based on the obfuscated source code to generate the assembly code representative of the machine code.

16. The system of claim 15, wherein the instructions further comprise a source code generator function programmed to cause a source code generator to generate program source code using a human-readable programming language based on the class diagram, wherein a compiled version of the program source code is functionally equivalent to the obfuscated source code.

17. The system of claim 12, wherein the clustering algorithm clusters the plurality of functions based on a frequency that a respective function calls another function of the plurality of functions.

18. The system of claim 12, wherein the modeling tool is further to generate one of a component diagram, a sequence diagram, an activity diagram, and a combination thereof based on the diagram modeling data communicated by the modeling function.

19. A system comprising:
memory to store machine readable instructions and data; and
one or more processors to access the memory and execute the instructions, the instructions comprising:
an interface programmed to receive assembly code representative of machine code compiled based on obfuscated source code;
a clustering function programmed to cause a clustering tool to apply a clustering algorithm to a plurality of functions of the assembly code to cluster the plurality of functions and define a plurality of classes based on relationships between the plurality of functions, wherein each class comprises a subset of functions of the plurality of functions, the plurality of classes being stored in the memory as diagram modeling data;
a modeling function programmed to cause a modeling tool to generate a diagram model based on the diagram modeling data, wherein the diagram model characterizes the obfuscated source code; and
a library function programmed to define a function library based on the diagram model, the function library comprising a subset of functions from a respective class, wherein the subset of functions of the function library is accessible by one or more external programs.

20. The system of claim 19, wherein the diagram model comprises a class diagram, the class diagram characterizes the obfuscated source code by identifying at least each class.
